(19) United States
(12) Patent Application Publication
(10) Pub. No.: US 2010/0118815 A1
(43) Pub. Date: May 13, 2010

(54) DISCONTINUOUS RECEPTION CONTROL METHOD OF USER EQUIPMENT IN WIRELESS COMMUNICATION SYSTEM

(75) Inventors: Soeng Hun KIM, Suwon-si (KR); Gert-Jan Van LIESHOUT, Apeldoorn (NL)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/615,604

(22) Filed: Nov. 10, 2009

(30) Foreign Application Priority Data
Nov. 10, 2008 (KR) 10-2008-0110929

(51) Int. Cl. H04W 40/00; H04W 72/04

(52) U.S. Cl. 370/329; 370/328

(57) ABSTRACT

A Discontinuous Reception (DRX) control method and apparatus are provided for determining a start time of the duration period of DRX operation in a wireless communication system using a short DRX cycle and a long DRX cycle. A DRX control method of a user equipment of the present invention includes determining one of a long DRX mode and a short DRX mode, configuring, when the short DRX mode is selected, the short DRX mode with a start time determined based on short DRX parameters, and configuring, when the long DRX mode is selected, the long DRX mode with a start time determined based on long DRX parameters.

### PRIORITY

This application claims the benefit under 35 U.S.C. §119(a) of a Korean patent application filed in the Korean Intellectual Property Office on Nov. 10, 2008 and assigned Serial No. 10-2008-0110929, the entire disclosure of which is hereby incorporated by reference.

### BACKGROUND OF THE INVENTION

1. Field of the Invention

The present invention relates to Discontinuous Reception (DRX) operation in a wireless communication system. More particularly, the present invention relates to a DRX control method and apparatus for determining a start time of an on duration period for DRX operation in a wireless communication system.

2. Description of the Related Art

A Universal Mobile Telecommunications System (UMTS) is a 3^{rd} generation (3G) mobile telecommunication technology. The UMTS evolved from the Global System for Mobile communications (GSM) and General Packet Radio Services (GPRS) and uses Wideband Code Division Multiple Access (WCDMA).

The 3rd Generation Partnership Project (3GPP), which is responsible for the standardization of UMTS, is working to significantly expand the performance of UMTS with the Long Term Evolution (LTE) standard. LTE is a 3GPP standard that provides for a downlink speed of up to 100 Mbps and is expected to be commercially launched in 2010.

In the LTE system, a Discontinuous Reception (DRX) mode is supported to prolong the User Equipment's (UE's) battery life. In DRX mode, the UE switches on the receiver to listen to the downlink control channel for an active period and then switches off the receiver for the inactive period following the active period to save the battery power. The switch-on time arrives periodically. In order to improve the power saving effect, two DRX cycle lengths are used for different types of services. In this case, the UE can transition between the two DRX cycle lengths when a transition event is fulfilled. Accordingly, the UE has to reset the switch-on time of the receiver whenever the DRX cycle transition occurs.

### SUMMARY OF THE INVENTION

An aspect of the present invention is to address at least the above-mentioned problems and/or disadvantages and to provide at least the advantages described below. Accordingly, an aspect of the present the present invention is to provide a Discontinuous Reception (DRX) control method and apparatus of a User Equipment (UE), in a wireless communication system using two different DRX cycles, that are capable of determining a start time of the on duration period for the DRX operation efficiently after a Radio Resource Control (RRC) connection reestablishment or a handover.

Another aspect of the present invention is to provide a DRX control method and apparatus of a UE, in a wireless communication system using two different DRX cycles, that are capable of improving power saving efficiency by accurately finding the wake-up time of the receiver regardless of the length of the DRX Start Offset.

In accordance with an aspect of the present invention, a DRX control method of a UE in a wireless communication system is provided. The method includes determining one of a long DRX mode and a short DRX mode, configuring, when the short DRX mode is selected, the short DRX mode with a start time determined based on at least one long DRX parameter, and configuring, when the long DRX mode is selected, the long DRX mode with a start time determined based on long DRX parameters.

In an exemplary implementation, the DRX control method further includes receiving the DRX parameters through signaling, wherein the DRX parameters include a DRX Start Offset, a long DRX cycle, a short DRX cycle, and an on duration timer.

In another exemplary implementation, the signaling is an RRC signaling.

In yet another exemplary implementation, the start time is determined at the beginning of a subframe satisfying [(SFN*10)+subframe number] modulo Short DRX Cycle)=(DRX Start Offset) modulo (Short DRX Cycle) in the short DRX mode.

In an exemplary implementation, the start time is determined at the beginning of a subframe satisfying [(SFN*10)+subframe number] modulo (Long DRX Cycle)=(DRX Start Offset) modulo (Long DRX Cycle) in the long DRX mode.

In still another exemplary implementation, determining one of a long DRX mode and a short DRX mode includes selecting, if no resource is assigned during a threshold time duration, the long DRX mode and, otherwise, selecting the short DRX mode.

In accordance with another aspect of the present invention, a DRX control method of a UE in a wireless communication system is provided. The method includes determining one of a long DRX mode and a short DRX mode, configuring, when the short DRX mode is determined, the short DRX mode with a start time at the beginning of an on duration period of a subframe satisfying [(SFN*10)+subframe number] modulo Short DRX Cycle)=(DRX Start Offset) modulo (Short DRX Cycle), and configuring, when the long DRX mode is determined, the long DRX mode with a start time at the beginning of an on duration period of a subframe satisfying [(SFN*10)+subframe number] modulo (Long DRX Cycle)=(DRX Start Offset) modulo (Long DRX Cycle).

In accordance with still another aspect of the present invention, a DRX control apparatus of a UE in a wireless communication system is provided. The apparatus includes a receiver for receiving a signal transmitted by a base station and for operating in one of a short DRX mode and a long DRX mode based on the received signal, an RRC unit for extracting DRX parameters from the signal, and a DRX controller for storing the DRX parameters provided by the RRC unit, for determining one of the long and short DRX modes, for configuring, when the short DRX mode is selected, the receiver to operate in the short DRX mode with a start time determined based on at least one long DRX parameter, and for configuring, when the long DRX mode is selected, the receiver to operate in the long DRX mode with a start time determined based on long DRX parameters.

In an exemplary implementation, the start time is determined at the beginning of a subframe, in the short DRX mode, satisfying [(SFN*10)+subframe number] modulo Short DRX Cycle)=(DRX Start Offset) modulo (Short DRX Cycle) and, in the long DRX mode, satisfying [(SFN*10)+subframe number] modulo (Long DRX Cycle)=(DRX Start Offset) modulo (Long DRX Cycle) in the long DRX mode.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description in conjunction with the accompanying drawings, in which:

FIG. 1 is a timing diagram illustrating transition timings between long and short Discontinuous Reception (DRX) cycles for explaining a DRX control method according to an exemplary embodiment of the present invention;

FIG. 2 is a flowchart illustrating a DRX control method of a User Equipment (UE) in a wireless communication system according to an exemplary embodiment of the present invention; and

FIG. 3 is a block diagram illustrating a configuration of a UE for supporting the DRX control method according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the following description, an exemplary method and apparatus for controlling operations of a User Equipment (UE) in a Discontinuous Reception (DRX) mode is described. In order to control the operations in a DRX mode, the DRX mode control method and apparatus of the present invention determines the start time of the active period of a short DRX mode using the parameters for determining the active period of a long DRX mode, thereby maintaining consistency of the determination of the start times of both the DRX modes and improving the resource reuse efficiency.

In the following description, the start times of the long and short DRX periods are defined, and an exemplary method to determine the start times of the short and long DRX modes more efficiently by defining their relationship is provided.

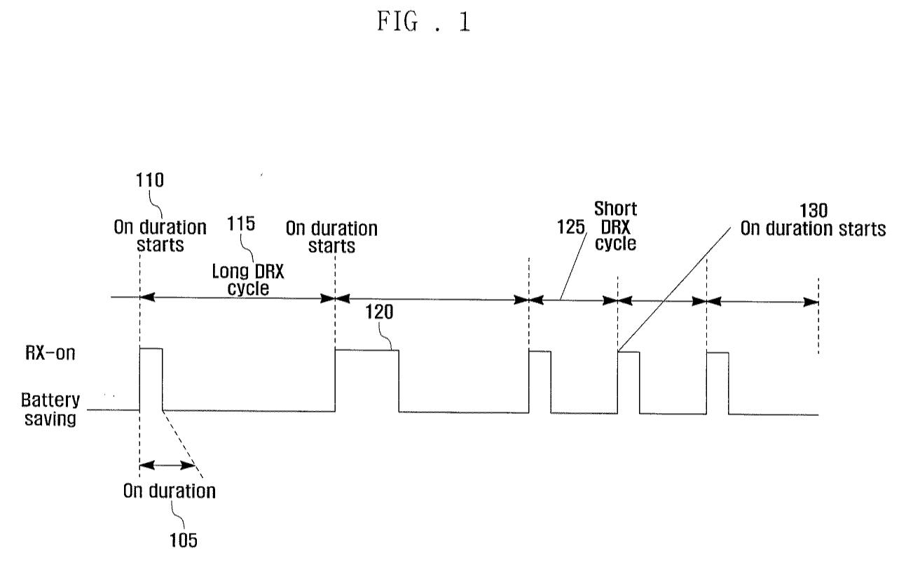

FIG. 1 is a timing diagram illustrating transition timings between long and short DRX cycles for explaining a DRX control method according to an exemplary embodiment of the present invention.

In FIG. 1, reference numeral 105 denotes an “on duration” during which the UE wakes up for monitoring the Physical Downlink Control Channel (PDCCH). The PDCCH is a downlink control channel for transmitting downlink and uplink resource assignments and other control information. If no scheduling is assigned during the on duration, the UE transitions to a sleep state to save battery power.

Reference numeral 115 denotes a “long DRX cycle” which is relatively long in length as compared to a “short DRX cycle”. The long DRX cycle is composed of the on duration period starting at the beginning 110 of the on duration period and a sleep period following the on duration period. As illustrated in a second long DRX cycle following the first long DRX cycle that includes on duration 110, the on duration of the DRX cycle need not be fixed. That is, the on duration 120 of the second long DRX cycle is greater than the on duration 110 of the previous long DRX cycle. The length of the on duration may vary depending on various system parameters.

Reference numeral 125 denotes a “short DRX cycle” which is relatively short in length as compared to the “long DRX cycle”. If a predefined transition event (e.g., scheduling assignment) occurs while operating with the long DRX cycle, the UE switches from the long DRX cycle to the short DRX cycle. While operating with the short DRX cycle, the UE wakes up at the beginning (on duration start time 130) of every short DRX cycle and stays on for the entire on duration period.

In order to determine the on duration start time, the UE and base station use a parameter called the DRX Start Offset. The DRX Start Offset is set to a value in the range from 0 to 2559. The DRX Start Offset is used to distribute the on duration start times of the UEs within a cell as equal as possible. In an exemplary embodiment, the base station determines a DRX Start Offset for each UE operating within the service coverage area of the base station. The base station transmits the DRX Start Offset to the UE and, using the received DRX Start Offset, the UE can determine on duration start times for long and short DRX cycles using equations as described below.

A UE operating with a long DRX cycle starts the on duration period in a subframe (not shown) satisfying equation (1).

[(SFN*10)+subframe number]modulo(Long DRX Cycle)=DRX Start Offset (1)

A UE operating with a short DRX cycle starts the on duration period in a subframe satisfying equation (2)

[(SFN*10)+subframe number]modulo(Short DRX Cycle)=DRX Start Offset (2)

In equations (1) and (2), SFN (System Frame Number) denotes a counter that is incremented by 1 every 10 msec. The SFN corresponds to a radio frame which is composed of 10 subframes, each of the subframes being assigned a subframe number from 0 to 9 in order. The SFN is included in system information that is broadcast within the service coverage area of the base station so that the UE and the base station commonly recognize the start time of the on duration period by referencing the SFN. Also in equations (1) and (2), the DRX Start Offset for the short DRX cycle may be different from the DRX Start Offset for the long DRX cycle.

In a case in which the DRX Start Offset is 16 for both the short DRX cycle and the long DRX cycle, the short DRX cycle is 256, and the long DRX cycle is 512, a UE operating with the long DRX cycle satisfies equation (1) at the following subframes and thus starts the on duration period at the corresponding subframes. Here, sf(x,y) denotes a y^{th} subframe in the system frame having the SFN x.
sf (1,6), sf (52, 8), sf (104, 0), sf (155, 2), . . . .

Similarly, a UE operating with the short DRX cycle satisfies equation (2) at the following subframes and thus starts the on duration period at the corresponding subframes.
sf (1,6), sf (27,2), sf (52,8), sf (78,4), . . . .

In a situation in which the DRX Start Offset for the short DRX cycle is shorter than the short DRX cycle, there always exist subframes that satisfy equations (1) and (2).

However, in a situation in which the DRX Start Offset for the short DRX cycle is greater than the short DRX cycle, while there always exist subframes that satisfy equation (1) there are not always subframes that satisfy equation (2). Accordingly, when a UE operates with the short DRX cycle and the DRX Start Offset is greater than the short DRX cycle, the DRX operation is likely to malfunction. In order to address this problem, a DRX reception control method according to an exemplary embodiment of the present invention establishes a new procedure for determining on duration start times using the DRX Start Offset for the long DRX cycle when the UE operates with the short DRX cycle. That is, the on duration start time for a short DRX cycle is obtained by processing the DRX Start Offset for use with the long DRX cycle using an equation according to an exemplary embodiment of the present invention.

By determining the on duration start time from the DRX Start Offset for the long DRX cycle, the base station need only transmit one DRX Start Offset, unlike the conventional method of transmitting two different DRX Start Offsets for the long and short DRX cycles individually. Furthermore, it is possible to maintain coherence between the DRX Start Offsets for the long and short DRX cycles.

In an exemplary embodiment of the present invention, the UE starts the on duration period (i.e., turns on the receiver) at the subframe satisfying equation (1) in the long DRX cycle mode and starts the on duration at the subframe satisfying equation (3) in the short DRX cycle mode. In an alternative exemplary embodiment described below, the UE starts the on duration period at the subframe satisfying equation (4) in the long DRX cycle mode. The UE may use equation (4) to ensure proper DRX operation in a case in which the DRX Start Offset may be greater than the long DRX cycle.

[(SFN*10)+subframe number]modulo(Short DRX Cycle)=(DRX Start Offset)modulo(Short DRX Cycle) (3)

The left and right terms of equation (3) are equal to each other even when the DRX Start Offset is shorter than the short DRX cycle. This means that there always exist subframes satisfying equation (3), whereby the UE and base station can determine the on duration start time so as to guarantee normal operation of the receiver of the UE.

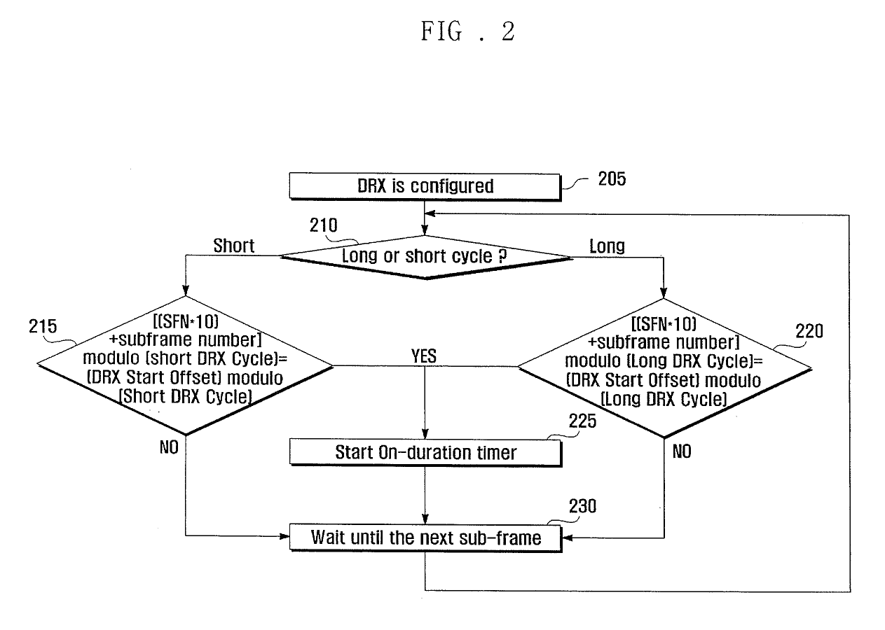

FIG. 2 is a flowchart illustrating a DRX control method of a UE in a wireless communication system according to an exemplary embodiment of the present invention.

Referring to FIG. 2, the UE configures the DRX operation under the control of a Radio Resource Control (RRC) layer in step 205. That is, the base station transmits the DRX parameters for DRX configuration (e.g., DRX Start Offset, long DRX cycle, short DRX cycle, on duration timer, etc.), and the UE stores the DRX parameters transmitted by the base station.

In step 210, the UE evaluates the parameters to determine whether to use the long DRX cycle or the short DRX cycle. In a situation in which the UE has not been assigned resources by the base station before, the long DRX cycle is used and, otherwise, the short DRX cycle is used. If it is determined to use the short DRX cycle, the UE proceeds to step 215. Otherwise, if it is determined to use the long DRX cycle, the UE proceeds to step 220.

If it is determined to use the short DRX cycle, the UE searches for a subframe satisfying equation (3) by substituting the current subframe number and SFN into equation (3) in step 215. If the current subframe satisfies equation (3), the UE starts an on-duration timer at the corresponding subframe in step 225. Here, the on-duration timer corresponds to the on duration period, and thus the start of the on-duration timer indicates the beginning of the on duration period. After the on-duration timer starts, the UE waits until the start of the next subframe in step 230. With the start of the next subframe, the UE returns to step 210 to repeat the aforementioned procedure.

If it is determined that the current subframe does not satisfy equation (3) at step 215, the UE waits until the start of the next subframe in step 230 and then returns to step 210 to repeat the aforementioned procedure.

Referring again to step 210, if it is determined to use the long DRX cycle, the UE searches for a subframe satisfying equation (4) by substituting the current subframe number and SFN into equation (4) in step 220.

[(SFN*10)+subframe number]modulo(Long DRX Cycle)=(DRX Start Offset)modulo(Long DRX Cycle) (4)

If the current subframe satisfies equation (4), the UE starts the on-duration timer at the corresponding subframe in step 225. Here, the on-duration timer corresponds to the on duration period, and thus the start of the on-duration timer indicates the beginning of the on duration period. After the on-duration timer starts, the UE waits until the start of the next subframe in step 230. With the start of the next subframe, the UE returns to step 210 to repeat the aforementioned procedure.

If it is determined in step 220 that the current subframe does not satisfy equation (4), the UE waits until the start of the next subframe in step 230 and then returns to step 210 to repeat the aforementioned procedure.

As described above, in an exemplary DRX control method for a wireless communication system using the short and long DRX cycles, the UE receives the DRX parameters from the base station and determines whether the current DRX cycle mode is a long DRX cycle mode or a short DRX cycle mode, based on the DRX parameter. If the current DRX cycle mode is the short DRX cycle mode, the UE starts the on-duration period at the beginning of the subframe satisfying equation (3). Otherwise, if the current DRX cycle mode is the long DRX cycle mode, the UE starts the on-duration period at the beginning of the subframe satisfying equation (4).

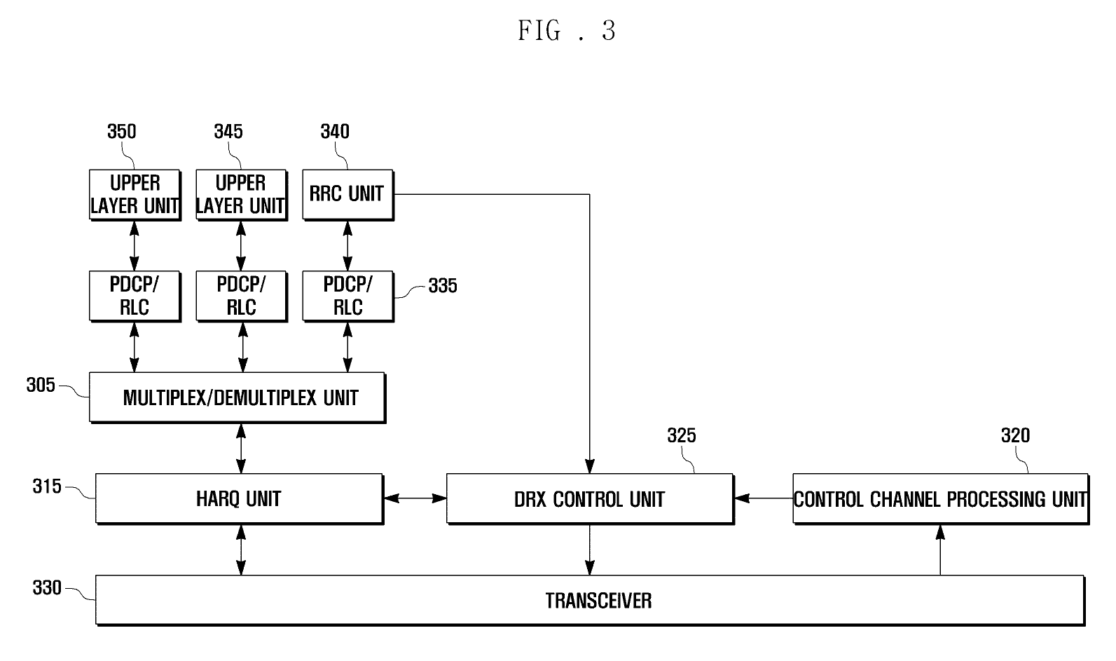

FIG. 3 is a block diagram illustrating a configuration of a UE for supporting the DRX control method according to an exemplary embodiment of the present invention.

As shown in FIG. 3, the UE includes a multiplex/demultiplex unit 305, a Hybrid Automatic Repeat Request (HARQ) unit 315, a transceiver 330, a DRX control unit 325, a control channel processing unit 320, a Packet Data Convergence Protocol/Radio Link Control (PDCP/RLC) unit 335, upper layer units 345 and 350, and an RRC unit 340.

The transceiver 330 is responsible for transmitting and receiving radio signals over radio channels. The DRX control unit 325 controls the DRX operation of the receiver according to a preset rule. The DRX control unit 325 receives the DRX parameters required for the DRX operation from the RRC unit 340. The DRX control unit 325 determines whether to start the on-duration timer using equations (3) and (4) and turns on the transceiver 330 when an on-duration timer start condition is satisfied. The HARQ unit 315 performs a HARQ operation to process HARQ packets received through the transceiver 330 and delivers the successfully received HARQ packets to the multiplex/demultiplex unit 305. The HARQ unit 315 processes the HARQ packets output from the multiplex/demultiplex unit 305 and transmits the HARQ packets by means of the transceiver 330. The multiplex/demultiplex unit 305 multiplexes the packets delivered from the upper layer units 345 and 350 into an HARQ packet and deliver the HARQ packet to the HARQ unit 315. The multiplex/demultiplex unit 305 also demultiplexes the HARQ packet delivered from the HARQ unit 315 into original data and delivers the original data to the corresponding upper layer units 345 and 350. The PDCP/RLC unit 335 is established per radio bearer to format the data from the upper layer units 345 and 350 and RRC unit 340 into a suitable data structure and delivers the formatted data to the multiplex/demultiplex unit 305. The PDCP/RLC unit 335 also delivers the data from the multiplex/demultiplex unit 305 to the upper layer unit 345 and 350 or an RRC unit 340. The RRC unit 340 receives the parameters related to the DRX operation from the base station and transfers the DRX parameters to the DRX control unit 325.

The transceiver 330 is turned off at the end of the on duration period before the next DRX cycle starts under the control of the DRX control unit 330, thereby saving battery power. That is, the transceiver 330 is turned on during the on duration to monitor the downlink control channel and turned off for the rest of the DRX cycle, resulting in battery power saving of the UE.

The RRC unit 340 of the above structured UE receives the DRX parameters transmitted by the base station and provides the DRX control unit 325 with the DRX parameters. The DRX control unit 325 receives the DRX parameters from the RRC unit 340 and determines whether the currently used DRX cycle is the long DRX cycle or the short DRX cycle. If it is determined that the current DRX cycle is the short DRX cycle, the UE configures the start time of the on duration period at the subframe that fulfils equation (3). Otherwise if it is determined that the current DRX cycle is the long DRX cycle, the UE configures the start time of the on duration period at the subframe that fulfils equation (4). Next, when the on duration timer start condition is satisfied, the DRX control unit 325 turns on the transceiver 330.

As described above, an exemplary DRX control method of the present invention enables the UE using two different DRX cycles to efficiently find the start time of the on duration even when the DRX Start Offset is greater than the DRX cycle, thereby avoiding malfunction of the DRX operation due to the inaccurate on duration period detection. With the stable DRX operation, power savings, resource management efficiencies and received signal quality are improved.

As described above, the signal transmission method and apparatus for a mobile communication system according to exemplary embodiments of the present invention enable a UE to discriminate the uplink transmission resource assignment messages indicative of initial transmission and retransmission of data accurately, thereby reducing waste of resource caused by misidentification of the uplink transmission resource assignment message.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A Discontinuous Reception (DRX) control method of a user equipment in a wireless communication system, the method comprising:
determining one of a long DRX mode and a short DRX mode;
configuring, when the short DRX mode is selected, the short DRX mode with a start time determined based on at least one long DRX parameter; and
configuring, when the long DRX mode is selected, the long DRX mode with a start time determined based on long DRX parameters.

2. The method of claim 1, further comprising receiving the DRX parameters through a signaling, the DRX parameters including a DRX Start Offset, a long DRX cycle, a short DRX cycle, and an on duration timer.

3. The method of claim 2, wherein the signaling comprises a Radio Resource Control (RRC) signaling.

4. The method of claim 2, wherein the start time is determined at the beginning of a subframe satisfying the equation:
[(SFN*10)+subframe number]modulo Short DRX Cycle)=(DRX Start Offset)modulo(Short DRX Cycle)in the short DRX mode.

5. The method of claim 4, wherein the start time is determined at the beginning of a subframe satisfying the equation:
[(SFN*10)+subframe number]modulo(Long DRX Cycle)=(DRX Start Offset)modulo(Long DRX Cycle)in the long DRX mode.

6. The method of claim 5, wherein the determining of one of the long DRX mode and the short DRX mode comprises selecting, if no resource is assigned during a predetermined time duration, the long DRX mode and, otherwise, selecting the short DRX mode.

7. The method of claim 1, further comprising:
monitoring, during an on-duration, a control channel for control information; and
if no control information is detected, transitioning to a sleep mode.

8. The method of claim 7, wherein the on-duration may vary between transmission frames.

9. A Discontinuous Reception (DRX) control method of a user equipment in a wireless communication system, the method comprising:
determining one of a long DRX mode and a short DRX mode;
configuring, when the short DRX mode is determined, the short DRX mode with a start time at the beginning of an on duration period of a subframe satisfying the equation [(SFN*10)+subframe number] modulo Short DRX Cycle)=(DRX Start Offset) modulo (Short DRX Cycle); and
configuring, when the long DRX mode is determined, the long DRX mode with a start time at the beginning of an on duration period of a subframe satisfying the equation [(SFN*10)+subframe number] modulo (Long DRX Cycle)=(DRX Start Offset) modulo (Long DRX Cycle).

10. The method of claim 9, further comprising receiving DRX parameters through a signaling, the DRX parameters including the DRX Start Offset, the long DRX cycle, the short DRX cycle, and an on duration timer.

11. The method of claim 10, wherein the signaling comprises a Radio Resource Control (RRC) signaling.

12. The method of claim 9, further comprising:
monitoring, during an on-duration, a control channel for control information; and
if no control information is detected, transitioning to a sleep mode.

13. The method of claim 12, wherein the on-duration may vary between transmission frames

14. A Discontinuous Reception (DRX) control apparatus of a user equipment in a wireless communication system, the apparatus comprising:
a receiver for receiving a signal transmitted by a base station and for operating in one of a short DRX mode and a long DRX mode based on the received signal;
a Radio Resource Control (RRC) unit for extracting DRX parameters from the signal; and
a DRX controller for storing the DRX parameters provided by the RRC unit, for determining one of the long and short DRX modes, for configuring, when the short DRX mode is selected, the receiver to operate in the short DRX mode with a start time determined based on at least one long DRX parameter, and for configuring, when the long DRX mode is selected, the receiver to operate in the long DRX mode with a start time determined based on long DRX parameters.

15. The apparatus of claim 14, wherein the start time is determined at the beginning of a subframe, in the short DRX mode, satisfying the equation [(SFN*10)+subframe number] modulo Short DRX Cycle)=(DRX Start Offset) modulo (Short DRX Cycle) and, in the long DRX mode, satisfying the equation [(SFN*10)+subframe number] modulo (Long DRX Cycle)=(DRX Start Offset) modulo (Long DRX Cycle) in the long DRX mode.
